(19) United States
(12) Patent Application Publication
(10) Pub. No.: US 2005/0152378 A1
(43) Pub. Date: Jul. 14, 2005

(54) Method of providing guaranteed delivery through the use of the internet for priority e-mail, files and important electronic documents

(76) Inventors: Joseph J. Bango, New Haven, CT (US); Michael E. Dziekan, Naugatuck, CT (US)

Correspondence Address: CONNECTICUT ANALYTICAL CORPORATION;JOSEPH J. BANGO, 696 AMITY ROAD, BETHANY, CT, 06524, US

(21) Appl. No.: 11/009,459

(22) Filed: Dec. 11, 2004

Related U.S. Application Data
(60) Provisional application No. 60/529,436, filed on Dec. 12, 2003.

(51) Int. Cl. H04L 12/56; H04L 12/28; H04L 12/66; H04L 12/26; H04L 1/00

(52) U.S. Cl. 370/400; 370/229; 370/395.21

(57) ABSTRACT

This invention details a method of providing a more robust, guaranteed and traceable electronic delivery system for providing next generation business e-mail. Unlike ordinary e-mail that we are all accustomed to today, which is considered to be free, there exists no current electronic document delivery or e-mail having the capability to guarantee or expedite delivery. The concept is similar to that of using Fed-Ex™, DHL™, or UPS™ instead of regular mail to send an important letter or document. Large shipping providers like Fed-Ex™, DHL™, or UPS™ will charge a nominal fee for their services related to expediting the delivery, as such, the same will be applied here.

### CROSS REFERENCE TO RELATED APPLICATIONS

Provisional Application No. 60/529436 was filed on 12 Dec. 2003

### BACKGROUND

1. Field of Invention

This invention details a method of providing a more robust, guaranteed and traceable electronic delivery system for providing next generation business e-mail. Unlike ordinary e-mail that we are all accustomed to today, which is considered to be free (although you have to pay some monthly fee for an internet service provider, so it really does cost some finite amount of money) there exists no current electronic document delivery or e-mail having the capability to guarantee or-expedite delivery. The concept is similar to that of using Fed-Ex™, DHL™, or UPS™ instead of regular mail to send an important letter or document (an alternative is to send a registered letter through the post office, which costs an additional amount compared to the normal postage rate). Large shipping providers like Fed-Ex™, DHL™, or UPS™ will charge a nominal fee for their services related to expediting the delivery, as such, the same will be applied here.

2. Background Description of Prior Art

In order to understand why this invention is needed for today's fast paced speed business world, a little history on the Internet will need to be addressed. Internet technology originally evolved in the early 1960's, at the instigation of the US Department of Defense (DOD), to enable strategic computer networks to remain operational in the event of one or more nodes being out of commission during a nuclear war. The logic was simple; bombing a system based on an individual mainframe computer network would result in only a few nodes being lost, while still allowing the other fully functional nodes to route around the damaged ones. This was achieved by using a methodology known as “packet switching”, which worked by breaking up a data file into small “packets” and transmitting them to another location by multiple routes where the packets would be re-assembled back into the original data file, with the duplicate data packets discarded. In 1969, the first packet-switching network was developed by the Pentagon's Defense Advanced Research Project's Agency (DARPA). It was called the ARPAnet, and the original network connected 4 research establishments; UCLA, Stamford Research Institute, UCSB, and the University of Utah. The ARPAnet was an experiment to try to establish “internetted” or “inter-networked” communications between several distinct computers or nodes to comprise a network. The term “internetted communications” or “inter-networked communications” became eventually shortened to just “Internet”. The initial connections were operating at a “Snails pace” compared with today's high-speed fiberoptic lines. To give an idea of the speed involved, the first connections were only operating at 2.4 k bits per second, and soon after increased to 56 k bits per second. Slow by today's standards, but fast for the time. It was later upgraded as technology improved on an incremental basis. By 1972 the network had expanded to incorporate 40 nodes. ARPAnet soon became a forum for the exchange of information and ideas among scientists and academics, and within a few years the number of computers connected to the network increased to more than 100. By the mid-1970's, many US government agency networks were linked by ARPAnet and, because the networks were of a disparate nature, a common network protocol called TCP/IP (Transmission Control Protocol/Internet Protocol) was developed and became the standard for inter-networking military computers. By 1983, the word “Internet” became the common term for referring to the worldwide network of military, research and academic computers. Some key people of note for the development of the ARPAnet's success are worth mentioning. Leonard Kleinrock, an MIT graduate student, who in 1961 published a paper entitled “Information Flow in Large Communication Nets”. This paper was the first work dealing with the concept of a “Packet Switching” methodology. The RAND Institute and the National Physics Laboratory in England did independent work in the concept of “Packet Switching” methodologies in 1964. Lawrence Roberts (a collogue of Leonard Kleinrock) published an overall plan for the development of the ARPAnet in 1966. In 1968, DARPA awarded four contracts to make up the ARPAnet; UCLA, Stamford Research Institute, University of California Santa Barbara, and the University of Utah. The end of 1969 connected the four host computers connected together into the initial ARPAnet, and the budding Internet was off the-ground. One by one computers at UCLA (hooked up by September), the Stanford Research Institute (hooked up in October), the University of California Santa Barbara (hooked up in November) and finally the University of Utah (hooked up in December) were brought online. On October 29^{th}, Charley Kline at UCLA sent the first packets. Charley tried to remotely log into the Stanford Research Institute's (SRI) computers from UCLA. This initial attempt resulted in the system crashing as the letter “G” of the word “LOGIN” was entered. Additional computers (nodes) were connected as time passed; one such mapping is outlined in FIG. 3. The map shows several connections linking computers throughout the continental United States. Slowly the bugs were worked out of the system and more and more computers were connected to the ARPAnet. In 1971, an engineer named Ray Tomlinson working at BBN Technologies in Cambridge Massachusetts, saw a limitation in the fact that the ARPAnet could only send files back and forth and had no provision for sending simple text messages. He modified some existing code, and came up with electronic mail, or more commonly, e-mail as we call it today. There were protocols for sending messages through networked computers at that time, but not for sending them through the ever-expanding ARPAnet. He is credited for creating the first Internet e-mail. The e-mail application that he wrote became the most widely used application of the ARPAnet for over a decade. Thanks to Ray Tomlinson, we can find out on a daily basis that we can lose weight fast, get a low interest mortgage, find a mate, get low cost prescription medications, and even enlarge the size of ones penis (if so equipped!). Like everything else in life, a good idea or concept will eventually get misused. SPAM used to only refer to a somewhat “meatlike” substance that a family consumed at mealtime—not a barrage of superfluous advertisements sent as e-mail.

It should be discussed that there exists a common point of confusion regarding the World Wide Web (WWW) and the Internet. Most people think that they are the same thing, when in fact they are not. The Internet is comprised of many independent routers and servers connected by high-speed links of wire or fiber optic cable, in addition to many Internet Service Providers (ISP's) that are in turn connected to many more users (you and I). The World Wide Web (WWW) is actually a point and click, graphical user interface that allows the user to more easily look at information on the Internet. It is a hypertext language and was created in 1990 by a scientist at the European High-Energy Particle Physics Laboratory (CERN), by the name of Tim Berners-Lee. He developed the concept of the World Wide Web (“WWW”, “W3” or simply “the web”) as we know it today. The web provides access via the Internet to media-rich documents known as web pages, which may contain formatted text, images and multimedia each web page has a unique address known as a Uniform Resource Locator or “URL”, which allows a page to link to any other page on the Internet via hyperlinks. Hyperlinks are “clickable” text or images, sometimes known as “hotspots”, embedded in the page itself. A URL is made up of the access method, the name of the server, the directory where the page is stored, and the file name of the page. The URL [http://www.microsoft.com/download/index.htm] refers to the file [index.htm] in the directory [download] on the web server [www.microsoft.com] using the [http] (HyperText Transport Protocol) access method. Web pages are stored on an Internet computer known as a web server and access to the server's pages is provided by a web browser—a web navigation tool with a user-friendly interface. A single page or a group of related pages are said to occupy a web site, which has a home page or starting point of reference. Web pages are constructed using a common language known as HTML (HyperText Mark-up Language), and access to the web for the general public is supplied by Internet Service Providers or ISPs, who charge monthly or yearly subscriptions for this service. The first web browser, known as Mosaic, was developed in 1993 at the National Center for Supercomputer Applications (NCSA) in the university of Illinois. The use of Mosaic spread rapidly through the academic community and within a year, more than 2 million users were browsing the web. Today however, the most popular web browsers are Microsoft's Internet Explorer and Netscape's Navigator. Tim Berners-Lee's initial hypertext language was HTML, and enabled the development of graphical Web pages. This made it easier to look at information located on the Internet because it was presented in a more visually oriented graphical form. It is kind like comparing Windows to DOS. In the “old days” of computing, there was DOS (Disk Operating System), and this was a cumbersome, unforgiving, command-line oriented approach to performing operations on the computer. Windows on the other hand, was a graphical user interface (GUI) that allowed the user to simply “point and click” with a mouse to do the same tasks. In addition the HTML, Tim Berners-Lee also created HTTP (HyperText Transfer Protocol), which enabled the user to “point and click” on a highlighted word or image of a web page to activate it. This could facilitate downloading a file, opening another web page, playing a music or video file, or bringing up another series of menus or information that are not stored physically on that particular website, but are “linked” through to another computer or node somewhere in the world via the Internet. The user does not have to type in the [http://www.Some_Web_Server_Somewhere.com/Some_Directory/Some_File.ht m] address, they just click on it with the mouse. We could have an Internet without the World Wide Web, but we could not have the World Wide Web without the Internet. A person could have a Windows operating system CD, but without a computer to run it on, it will do no good. The World Wide Web (or as it is affectionately know to some—World Wide Wait—due to increased internet traffic flow) without the Internet is like having an operating system CD without a computer. It is important to understand that the World Wide Web is NOT the Internet, just a GUI for the Internet.

### BRIEF DESCRIPTION OF THE DRAWINGS

FIG. 1:

Description of the organization of a datagram of an IP (Internet Protocol) data packet with each byte detailed as to its function.

FIG. 2:

Description of the organization of a datagram of a TCP (Transport Control Protocol) data packet with each byte detailed as to its function.

FIG. 3:

Descriptive image of a node map showing main connections outlined on a map of the continental United States.

FIG. 4:

Schematic of a simplified Internet showing all possible routes through connections between computers and the main connections between routers which make up the simplified Internet.

FIG. 5:

Schematic of a simplified Internet showing one possible route through which a data packet might travel through the connections between computers and the main connections between routers which make up the simplified Internet.

FIG. 6:

Schematic of a simplified Internet showing the shortest possible route through which a data packet would have to travel through the connections between computers and the main connections between routers which make up the simplified Internet, to travel the shortest number of hops.

FIG. 7:

Schematic of a simplified Internet showing all possible routes through connections between computers and the main connections between routers which would make up a more “real world” Internet.

FIG. 8:

Detail showing bit structure of single 8-bit byte of the IP datagram showing the TOS (Type Of Service) byte for IP version 4 (Ipv4) protocol.

FIG. 9:

Drawing of a flowchart block diagram showing how the incoming data packet would be processed by an Internet router.

### DETAILED DESCRIPTION OF INVENTION

Current e-mail protocols enable a user to send and receive e-mails, 24 hours a day, 7 days a week, 365 days a year (assuming that the ISP's server has not crashed again!). The general concept is that e-mail is free, but this is a misnomer—in order to send e-mail, you need to be connected to the Internet by an Internet Service Provider, or ISP. Typical ISP's include Earthlink, AOL, Sprint, and SBC, to name just a few. These ISP's charge a nominal monthly fee for their service (or lack on, and thus get paid whether or not any e-mails are sent. If you are using a company e-mail system, then the company had to spend money to set up its network Internet link, maintain its servers, pay for its T1 line, Digital Subscriber Line (DSL) or Dial-up line, not to mention the salary's of the IT people who maintain and upgrade all this infrastructure. When it comes down to it, there is no free lunch. The problem with regular e-mail service is that it is usually queued up on a server before it is sent out through the Internet, and then it is sent out on a first come, first served basis. When the e-mail is broken down into individual packets, and is making its journey through the myriad of possible connections and routers throughout the Internet, there is no special priority associated with it. That is to say, an e-mail from Alice telling about how Bobby told Sally about what Jimmy told Laura, etc. will have equal importance to the Internet routers as an e-mail from the President of Acme corporation saying that the $250 million dollar contract is about to be cancelled if the engineering team doesn't fix a minor bug in the operating system. There is no distinction between e-mails sent throughout the Internet. Although several e-mail client's such as Outlook Express will enable the creation of an e-mail that can be marked as a priority message, the routing throughout the Internet is handled just as any other message, it is only “flagged” as being a priority message when it is downloaded. In addition, when a user is reading their e-mail, the order at which the e-mails are downloaded to their computer is in the order that the ISP's e-mail server received them. The proposed invention describes a method that will enable any priority message to be the first that will be downloaded to the user computer, no matter when the original e-mail was sent. What is needed is a way to tell the Internet, that a message, document, or file that is flagged in the described manner will have a priority routing associated with it. Although this cannot guarantee that a e-mail, document, or file that is sent through this priority service will be read as soon as it arrives, it will guarantee that it will arrive at the destination mail server in the shortest amount of time, and will send back an electronic receipt that the message was downloaded to the destination computer. This receipt methodology is currently incorporated in the existing e-mail capabilities, but it must be specifically asked to do this function, and the person who receives the e-mail has the option of sending or not sending a confirmation receipt that the e-mail was received. With the priority e-mail system, the receipt functionality will be automatic, and will send two receipts—the first receipt indicating that the e-mail reached its destination e-mail server, and the second when the person who the e-mail was intended for, downloads the e-mail from their ISP's e-mail server (checks their e-mail). An additional feature would enable the person for whom the e-mail is intended, would be for an automated message to call the persons cell phone, work phone, pager, or wireless appliance, and let them know that a priority e-mail, document or file was sent to them. This may not be practical in all instances, but it could be an optional feature.

To understand how this could be accomplished, a little understanding of Internet communication must be understood. There are several layers of communication that must be addressed when dealing with networked communication. They are listed as follows;
1) Physical Layer (Lowest)
2) Link Layer or Data-Link Layer
3) Network Layer
4) Transport Layer
5) Session Layer
6) Presentation Layer
7) Application Layer (Highest)

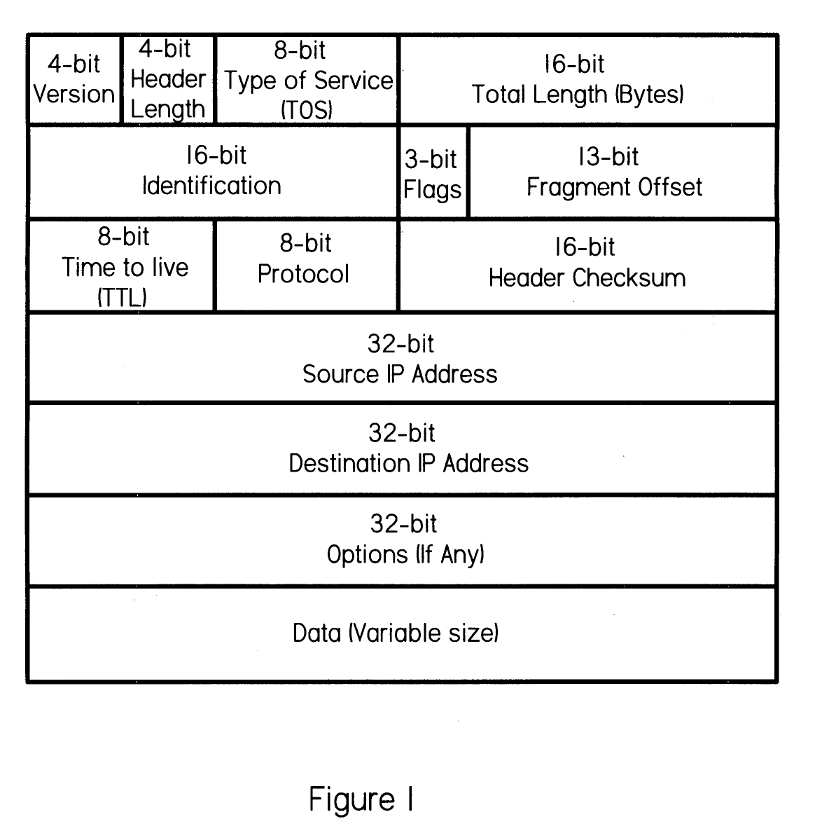

The lowest communication layer is called the Physical Layer [First Layer]. This is just as the name implies—a physical connection via twisted pair copper cable, fiber optic cable, coax cable, or even by a non-physical wireless RF link. The hardware connections make up this lowest layer of any network. The next layer is called the Link Layer or Data-Link Layer [Second Layer]. This layer tells how data will be transformed before being sent over communications lines in addition to any error detection. The next layer is called the Network Layer [Third Layer]. This layer handles the routing of data packets and the addressing capabilities for the network. On its own, the Network layer is unreliable, and will suffer data (packet) loss. The next layer is called the Transport Layer [Fourth Layer]. This layer is provided to make the Network communications more robust and reliable, and also provides data security features. The next layer is called the Session Layer [Fifth Layer]. This layer is encountered whenever there exists a logical connection between two nodes of a Network. This layer will enable a session (communication between two specific nodes) to be controlled, by providing a start of the session, overall session management, and ending the session when over. A session could consist of downloading/uploading a file, or sending/receiving e-mail. It handles temporary connections made between nodes. The next layer is called the Presentation Layer [Sixth Layer]. This layer handles communication syntax and data translation where required, and display, formatting, and appearance of information of devices, such as monitors. The final and highest communication layer is the Application Layer [Seventh Layer]. This layer is the one we deal with on a daily basis. A web browser like Internet Explorer or Netscape is an application layer program, as is the Outlook express e-mail, program. This layer consists of the commonly used programs that are running on our PC's and laptop computers. They communicate through the Internet through the use of successive lower layers. The internet has a base communication called Internet Protocol (IP). This is a Network-layer [Third Layer] protocol that contains addressing information and some control information that enables packets to be routed. IP is documented in RFC 791 (Request For Comments) and is the primary network-layer protocol in the Internet protocol suite. Along with the Transmission Control Protocol (TCP) that makes up the Transport Layer [Fourth Layer], IP represents the heart of the Internet protocols. IP has two primary responsibilities: providing connectionless, best-effort delivery of datagrams through an internetwork; and providing fragmentation and reassembly of datagrams to support data links with different Maximum Transmission Unit (MTU) sizes. The fields in the IP Packet Header are indicated in FIG. 1 and can be described as follows:

Version—This could indicate IPv4 or Ipv6, so this field has a value of four for Ipv4 or six for Ipv6. (We will be dealing with current IP version 4 (IPv4) for this description).

Header Length—The length of the IP header in 32-bit words—five if no options are present.

Type of Service—A bitmask field containing information on service constraints and precedence of packets. In theory, ToS values would allow IP packets to be routed or prioritized based on the traffic carried—in practice; few applications use this facility in current implementations.
Total Length—The total length of the datagram in bytes (up to 65535 bytes). In general, however, packet sizes are constrained by the underlying protocol. Unless some path MTU mechanism is used, IP fragmentation is used for oversize packets.
Identification—A number that uniquely identifies an IP datagram for use in packet defragmentation.
Flags—Contains the DF (Don't Fragment) and MF (More Fragments) flags; used to control datagram fragmentation.
Fragment offset—Offset of this fragment from the beginning of the datagram, in units of 8 bytes.
Time to Live (TTL)—Indicates an upper limit to the number of routers a packet may traverse. Each router (gateway) that a packet traverses decrements this value by one (or more) and the packet is discarded when this value reaches zero.
Protocol—A numerical field indicating which protocol is encapsulated in this packet.
Checksum—A 16-bit one's complement sum of the IP header, used to detect packet corruption in transit. No error message is generated on a corrupted packet discard.
Source IP Address—The IP address of the host interface that generated this packet.
Destination IP Address—The IP address of the host interface to which this packet is directed, or the IP address associated with a broadcast or multicast group.
IP Options—An IP header may, optionally, include special fields to modify packet handling on the IP level (padded out to 32-bit boundaries if needed). Currently available options include:
   Security: Used to send packet security information (military use).
   Loose Source Routing: Specifies nodes that the packet must traverse en route, but allows arbitrary intermediary nodes.
   Strict Source Routing: Specifies nodes that the packet must traverse en route—the packet is restricted to only traverse those specific nodes.
   Record Route: Allows the packet to record which nodes (up to the maximum header length) have been traversed en route.
   Internet Timestamp: Similar to Record Route, but each entry is also branded with the router time (GMT) in milliseconds.
Data—The datagram payload, identified by the Protocol field.

The Internet Protocol (IP) is the basis of the Internet and the TCP/IP suite. It has a number of notable aspects:
1) Delivery is host-to-host: each device is identified by a unique IP address, to which any packets for that device are routed.
2) IP is a “datagram” service: data is segmented into discrete packets, each of which contains sufficient header information to allow delivery of that packet.
3) IP is connectionless: there is no connection setup or teardown. Any packet is routed according to the current Network State at the time of transfer.
4) IP is unreliable: when an intermediary-node has insufficient resources to process a packet, it is simply discarded—IP allows, but does not require, an error notification to be returned. Protocols built upon IP must compensate for this if necessary.
5) IP routes packets in a next-hop fashion: each intermediary node forwards packets to its best guess at the optimal next waypoint. Incorrect routing tables can result in out-of-order packet delivery or packet looping.
6) IP offers packet fragmentation, allowing large packets to be transferred over connections that limit packet sizes. Packet fragmentation is currently depreciated for TCP, which has a path MTU (Maximum Transmission Unit) discovery mechanism.
7) IP has no inherent flow control: higher layer protocols must handle network congestion and under-utilization directly.

Because IP needs some help in making a more robust connection and acknowledging receipt of the packet, the use of Transport Control Protocol (TCP) is implemented over IP, or more commonly referred to as TCP/IP. The TCP provides reliable transmission of data in an IP environment by the use of full duplex operation. TCP corresponds to the Transport Layer [Layer four]. Among the services TCP provides are stream data transfer, reliability, efficient flow control, full-duplex operation, and multiplexing. With stream data transfer, TCP delivers an unstructured stream of bytes identified by sequence numbers. This service benefits applications, or application layer programs, because they do not have to chop data into blocks before handing it off to TCP. Instead, TCP groups bytes into segments and passes them to IP for delivery. TCP offers reliability by providing connection-oriented, end-to-end reliable packet delivery through an internetwork. It does this by sequencing bytes with a forwarding acknowledgment number that indicates to the destination the next byte the source expects to receive. Bytes not acknowledged within a specified time period are retransmitted. The reliability mechanism of TCP allows devices to deal with lost, delayed, duplicate, or misread packets. A time-out mechanism allows devices to detect lost packets and request retransmission. TCP offers efficient flow control, which means that, when sending acknowledgments back to the source, the receiving TCP process indicates the highest sequence number it can receive without overflowing its internal buffers. Full-duplex operation means that TCP processes can both send and receive at the same time. Finally, TCP's multiplexing means that numerous simultaneous upper-layer conversations can be multiplexed over a single connection. TCP used in conjunction with IP enables reliable base communication over the Internet.

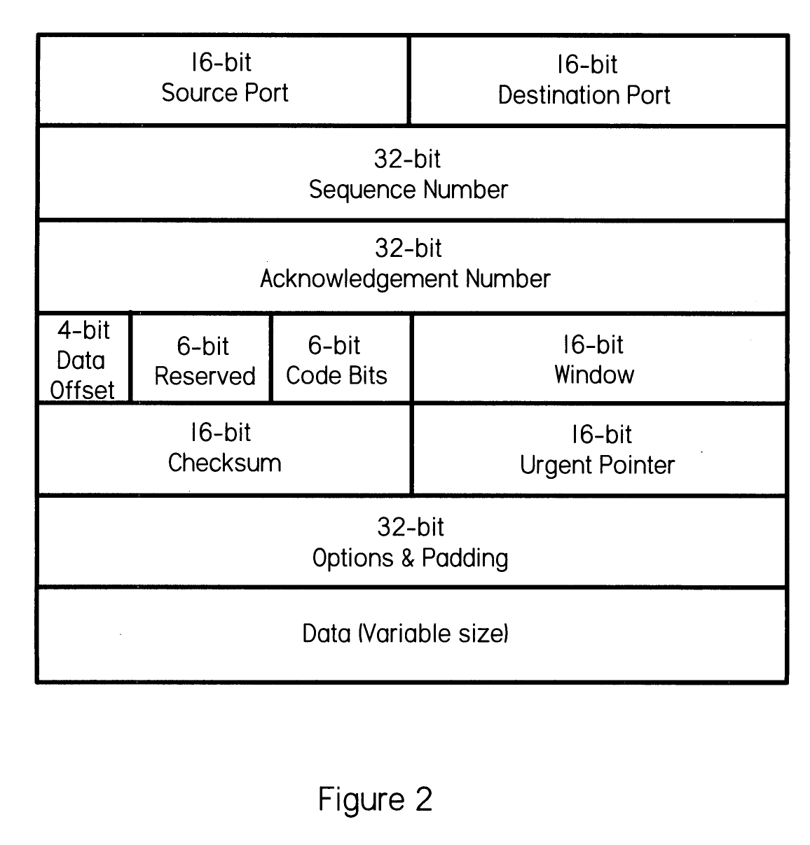

FIG. 2 shows a detail of a TCP datagram. The Transport Control Protocol (TCP) as part of the TCP/IP suite. It has a number of notable aspects:
Source Port and Destination Port—Identify points at which upper-layer source and destination processes receive TCP services.
Sequence Number—Usually specifies the number assigned to the first byte of data in the current message. In the connection-establishment phase, this field also can be used to identify an initial sequence number to be used in an upcoming transmission.
Acknowledgment Number—Contains the sequence number of the next byte of data the sender of the packet expects to receive.
Data Offset—Indicate the number of 32-bit words in the TCP header.
Reserved—Remains reserved for future use.
Code Bits (Flags)—Carry a variety of control information, including the SYN, ACK, URG, PSH, RST, and the FIN bit which is used for connection termination.
Window—Specifies the size of the sender's receive window (that is, the buffer space available for incoming data).
Checksum—Indicate whether the header was damaged in transit.
Urgent Pointer—Points to the first urgent data byte in the packet.
Options—Specify various TCP options.
Data—Contains upper-layer information.

The Flag byte (6 code bits) of the TCP protocol are as follows:
URG—URGent pointer field is significant
ACK—ACKnowledgement field is significant
PSH—PuSH function requested
RST—ReSeT the connection
SYN—SYNchronize sequence numbers
FIN—FiNish—No more data coming from sender

The URG, or Urgent bit could be used to indicate that the TCP data packet is marked as having urgent data to be processed through the IP or Network layer of Internet network communication. This could facilitate a priority Internet routing connection to help guarantee that priority e-mail or priority files make it to their desired destination. With the help of TCP, IP forms a reliable base communication layer. Now with a reliable base layer established, application layer protocols are feasible. Some of these application layer protocols are:

Simple mail transfer protocol (SMTP)
1) Basic email facility
2) Mechanism to transfer messages across hosts
3) Features include mailing lists, return receipts, and forwarding
4) Does not specify message creation; just the transfer of message using TCP

File transfer protocol (FTP)
1) Transfer files across systems under user commands
2) Can accommodate both text and binary files
3) Upon request, sets up a TCP connection to target system for exchange of control messages
4) Connection allows user to send authentication and files with desired file actions
5) Upon approval, a second TCP connection is opened for actual data transfer
6) Second connection avoids the overhead of control information at the application level
7) After file transfer is complete, control connection is used to signal completion and accept new commands

Telnet

1) Remote logon capability
2) Designed to work with simple scroll-mode terminals
3) Implemented in two modules
   A) User telnet
      1) Interacts with terminal I/O module to communicate with a local terminal
      2) Converts characteristics of real terminals to network standards and vice versa
   B) Server telnet
      1) Interacts with an application, acting as a surrogate terminal handler
      2) Makes remote terminal appear as local to the application
      3) Traffic between user and server telnet is carried on a TCP connection

The main application layer protocols that we will be concerned with are Simple Mail Transfer Protocol (SMTP), and Post Office Protocol (POP3). These protocols are responsible for dealing with sending and receiving e-mail—POP3 for receiving, and SMTP for sending. Now that we have some understanding of the intricacies of the Internet, we can detail how e-mail is handled. The Internet could be classified a being comprised of millions of computers, of which there are two different types—clients and servers. Although this is not exact in the most detailed sense, it will suffice for our discussion. The machines that provide services to other machines are servers, and the machines that are used to connect to those services are clients. Clients are also referred to as programs that are running on a computer. Throughout the vast Internet there are Web servers, e-mail servers, FTP servers and so on serving the needs of Internet users all over the world. When you connect to a website, you are a user sitting at a client's machine. You are accessing their Web server. The server machine finds the requested page and sends it. Clients that come to a server machine do so with a specific intent, and direct their requests to a specific software server running on the server machine. For example, if you are running a Web browser on your machine, it will want to talk to the Web server on the server machine, not the e-mail server. A server has a static IP address that does not change very often. A home machine that is dialing up through a modem, on the other hand, typically has an IP address assigned by the ISP every time you dial in. That IP address is unique for your session—it may be different the next time you dial in. This way, an ISP only needs one IP address for each modem it supports, rather than one for each customer. Any server machine makes its services available using numbered ports—one for each service that is available on the server. For example, if a server machine is running a Web server and a file transfer protocol (FTP) server, the Web server would typically be available on port 80, and the FTP server would be available on port 21. Clients connect to a service at a specific IP address and on a specific port number. Once a client has connected to a service on a particular port, it accesses the service using a specific protocol. Protocols are often text and simply describe how the client and server will have their conversation. Every Web server on the Internet conforms to the hypertext transfer protocol (HTTP). What is still needed to enable a detailed description of the described invention is a look at how e-mail is handled on the Internet. Any person who uses a computer has probably already received several e-mail messages today. To look at them, some sort of e-mail client must be used. Many people use well-known stand-alone clients like Microsoft Outlook, Outlook Express, Eudora or Pegasus. People who subscribe to free e-mail services like Hotmail or Yahoo use an e-mail client that appears in a Web page. If you unfortunate enough to be an AOL customer, you use AOL's e-mail reader. No matter which type of client you are using, it generally does four things:
1) Displays a list of all of the messages in the mailbox by displaying the message headers. The header shows who sent the mail, the subject of the mail and may also show the time and date of the message and the message size.
2) Selects a message header and read the body of the e-mail message.
3) Creates and sends new messages.
4) Enables attachments to be added to messages.

Most e-mail clients, in addition to receiving, composing and sending e-mail, will also let attachments be added to messages. Sophisticated e-mail clients may have all sorts of bells and whistles, but at the core, they are all fairly simple. Once an e-mail client (program) is installed on a computer, all that is left is an e-mail server for the client to connect to. This is usually done by first connecting a persons computer to their Internet Service Provider (ISP) through either a dial-up connection, DSL line, cable modem, or wireless modem. Next, they will be prompted to enter their username and password. Once verified, they are logged onto their ISP's server. They then have the option to connect to various other servers throughout the Internet—Web servers, FTP servers, telnet servers and e-mail servers. These applications run all the time on the server machine and they listen to specific ports, waiting for people or programs to attach to the port. The simplest possible e-mail server (non-real) would work something like this example given from the website “HowStuffWorks.com”, called “How E-mail works”: The e-mail server would have a list of e-mail accounts, with one account for each person who can receive e-mail on the server. The user account name might be “mbrain”, John Smith's might be “jsmith”, and so on. A text file would exist for each account in the list, so the server would have a text file in its directory named MBRAIN.TXT, another named JSMITH.TXT, and so on. If someone wanted to send “mbrain” a message, the person would compose a text message (“Dude, Where's my car? John”) in an e-mail client, and indicate that the message should go to “mbrain”. When the person presses the Send button, the e-mail client would connect to the e-mail server and pass to the server the name of the recipient “mbrain”, the name of the sender “jsmith” and the body of the message. The server would format those pieces of information and append them to the bottom of the MBRAIN.TXT file. The entry in the file might look like this:
From: jsmith
To: mbrain
Dude,
Where's my car?
John

There are several other pieces of information that the server might save into the file, such as the time and date of receipt and a subject line; but overall, one can see that this is an extremely simple process. As other people send mail to “mbrain”, the server would simply append those messages to the bottom of the file in the order that they arrived. Depending on or it would accumulate a series of 25 or 50 messages. Eventually the user would log in and read them. When the user wants to look at their e-mail (in this case “mbrain”), the e-mail client would connect to the server machine. In the simplest possible system, it would do the following:
1) Ask the server to send a copy of the MBRAIN.TXT file
2) Ask the server to erase and reset the MBRAIN.TXT file
3) Save the MBRAIN.TXT file on my local machine
4) Parse the file into the separate messages (using the word “From:” as the separator)
5) Show “mbrain” all of the message headers in a list

When a message header is double-clicked, it would find that message in the text file and show its body. This is a very simple system, and surprisingly, the real e-mail system that is used every day is not much more complicated than this! In a real e-mail system there are two different servers running on a server machine. One is called the SMTP server, which handles all outgoing mail, and the other is either a POP3 server or an IMAP (Internet Mail Access Protocol) server, both of which handle incoming mail. A typical “real-world” e-mail server looks like the following. The SMTP server listens on well-known port number 25, POP3 listens on port 110 and IMAP uses port 143. Whenever a piece of e-mail is sent, the e-mail client interacts with the SMTP server to handle the sending. The SMTP server on the ISP (your host) may have conversations with other SMTP servers to actually deliver the e-mail. Assume that “mbrain” wants to send an e-mail to his friend “jsmith”. An account exists on howstuffworks.com for “mbrain”, who wants to send an e-mail to jsmith@mindspring.com. The e-mail client that “mbrain” is using is a stand-alone e-mail client like Outlook Express. When “mbrain” set up their account at howstuffworks, they told Outlook Express the name of the mail server—[mail.howstuffworks.com]. Whenever a message is composed by “mbrain” and sent by pressing the Send button in Outlook Express, here is what happens:
1) Outlook Express connects to the SMTP server at [mail.howstuffworks.com] using port 25.
2) Outlook Express has a conversation with the SMTP server, telling the SMTP server the address of the sender and the address of the recipient, as well as the body of the message.
3) The SMTP server takes the “to” address asmith@mindspring.com) and breaks it into two parts:
   A) The recipient name (smith)
   B) The domain name (mindspring.com)

If the “to” address had been another user at [howstuffworks.com], the SMTP server would simply hand the message to the POP3 server for howstuffworks.com (using a little program called the delivery agent). Since the recipient is at another domain, SMTP needs to communicate with that domain. The SMTP server has a conversation with a Domain Name Server, or DNS. The DNS will be used to resolve the Internet address, IP address from the domain name. The domain name in this case is [howstuffworks.com], and its corresponding IP address would be needed for the Internet to route the data to the correct address. Just for reference, the IP address that would be returned by the DNS server is 216.27.61.137. The DNS says, “Can you give me the IP address of the SMTP server for mindspring.com?” The DNS replies with the one or more IP addresses for the SMTP server(s) that Mindspring operates. The SMTP server at [howstuffworks.com] connects with the SMTP server at Mindspring using port 25. It has the same simple text conversation that my e-mail client had with the SMTP server for [HowStuffWorks], and gives the message to the Mindspring server. The Mindspring server recognizes that the domain name for “jsmith” is at Mindspring, so it hands the message to Mindspring's POP3 server, which puts the message in “jsmith's” mailbox. If, for some reason, the SMTP server at [HowStuffWorks] cannot connect with the SMTP server at Mindspring, then the message goes into a queue. The SMTP server on most machines uses a program called SENDMAIL to do the actual sending, so this queue is called the SENDMAIL queue. SENDMAIL will periodically try to resend the messages in its queue. For example, it might retry every 15 minutes. After several hours, it will usually send you a piece of mail that tells you there is some sort of problem. After five days, most SENDMAIL configurations give up and return the mail to the sender undelivered. The actual conversation that an e-mail client has with an SMTP server is incredibly simple and human readable. It is specified in public documents called Requests For Comments (RFC), and a typical conversation looks something like this:

| | |
|---|---|
| E-mail Client: | helo test |
| SMTP Server: | 250 mx1.mindspring.com Hello abc.sample.com |
| SMTP Server: | [220.57.69.37], pleased to meet you |
| E-mail Client: | mail from: test@sample.com |
| SMTP Server: | 250 2.1.0 test@sample.com... Sender ok |
| E-mail Client: | rcpt to: jsmith@mindspring.com |
| SMTP Server: | 250 2.1.5 jsmith... Recipient ok |
| E-mail Client: | data |
| SMTP Server: | 354 Enter mail, end with “.” on a line by itself |
| E-mail Client: | from: test@sample.com |
| E-mail Client: | to: jsmith@mindspring.com |
| E-mail Client: | subject: testing |
| E-mail Client: | John, I am testing... |
| SMTP Server: | 250 2.0.0 e1NMajH24604 Message accepted for |
| | delivery |
| E-mail Client: | quit |
| SMTP Server: | 221 2.0.0 mx1.mindspring.com closing connection |
| SMTP Server: | Connection closed by foreign host. |

What the e-mail client sends and the SMTP server replies is shown above. The e-mail client introduces itself, indicates the “from” and “to” addresses, delivers the body of the message and then quits. You can, in fact, telnet to a mail server machine at port 25 and have one of these dialogs yourself—this is how people “spoof” e-mail. It can be seen that the SMTP server understands very simple text commands like HELO, MAIL, RCPT and DATA. The most common SMTP commands are:
HELO—introduce yourself
EHLO—introduce yourself and request extended mode
MAIL FROM:—specify the sender
RCPT TO:—specify the recipient
DATA—specify the body of the message (To:, From: and Subject: should be the first three lines.)
RSET—reset
QUIT—quit the session
HELP—get help on commands
VRFY—verify an address
EXPN—expand an address
VERB—verbose

In the simplest implementations of POP3, the server really does maintain a collection of text files, one for each e-mail account. When a message arrives, the POP3 server simply appends it to the bottom of the recipient's file! When a user checks their e-mail, the e-mail client connects to the POP3 server using port 110. The POP3 server requires an account name and a password. Once logged in, the POP3 server opens the users text file and allows access to it. Like the SMTP server, the POP3 server understands a very simple set of text commands. Here are the most common commands:
USER—enter your user ID
PASS—enter your password
QUIT—quit the POP3 server
LIST—list the messages and their size

RETR—retrieve a message, pass it a message number
DELE—delete a message, pass it a message number
TOP—show the top x lines of a message, pass it a message number and the number of lines

The users e-mail client connects to the POP3 server and issues a series of commands to download copies of their e-mail messages to their local machine. Generally, it will then delete the messages from the server (unless the e-mail client was configured not to). The POP3 server acts as an interface between the e-mail client and the text file containing the users messages. One can also see that the POP3 server is extremely simple! The POP3 protocol allows the user to have a collection of messages stored in a text file on the e-mail server. The users e-mail client (Outlook Express) can connect to the POP3 e-mail server and download the messages from the POP3 text file onto your PC. That is about all that can be done with POP3. Some users want to do more than that with their e-mail, and want their e-mail to remain on the server. The main reason for keeping your e-mail on the server is to allow users to connect from a variety of machines. With POP3, once you download your e-mail it is stuck on the machine to which you downloaded it. If you want to read your e-mail both on your desktop and your laptop, POP3 makes life difficult. IMAP (Internet Mail Access Protocol) is a more advanced protocol that solves these problems. With IMAP, your mail stays on the e-mail server. E-mail could be organized into folders, and those folders live on the server as well. When you search your e-mail, the search occurs on the server machine, rather than on your machine. This approach makes it extremely easy for you to access your e-mail from any machine, and regardless of which machine you use, you have access to all of your mail in all of your folders. The e-mail client connects to the IMAP server using port 143 and issues a set of text commands that allow it to do things like list all the folders on the server, list all the message headers in a folder, get a specific e-mail message from the server, delete messages on the server or search through all of the e-mails on the server. One problem that can arise with IMAP involves this simple question: “If all of my e-mail is stored on the server, then how can I read my mail if I am not connected to the Internet?” To solve this problem, most e-mail clients have some way to cache e-mail on the local machine. For example, the client will download all the messages and store their complete contents on the local machine Oust like it would if it were talking to a POP3 server). The messages still exist on the IMAP server, but you now have copies on your machine. This allows you to read and reply to e-mail even if you have no connection to the Internet. The next time a connection is established, the user can download all the new messages received while disconnected and send all the mail that was composed while disconnected (offline).

As stated before, the e-mail client allows the addition of attachments to e-mail messages sent, and also lets received attachments be saved. Attachments might include word processing documents, spreadsheets, sound files, snapshots and pieces of software. Usually, an attachment is not text. Since e-mail messages can contain only text information, and attachments are not text, there is a problem that needs to be solved. In the early days of e-mail, this was solved by using a program called UUENCODE. The UUENCODE program assumes that the file contains binary information. It extracts 3 bytes from the binary file and converts them to four text characters (that is, it takes 6 bits at a time, adds 32 to the value of the 6 bits and creates a text character). What UUENCODE produces, therefore, is an encoded version of the original binary file that contains only text characters. In the early days of e-mail, one would run UUENCODE yourself and paste the uuencoded file into your e-mail message. The recipient would then save the uuencoded portion of the message to a file and run UUDECODE on it to translate it back to binary. Modern e-mail clients are doing exactly the same thing, but they run UUENCODE and UUDECODE automatically. Now we can outline how this described invention will permit one user to send another user (anywhere in the world!) an e-mail that will be guaranteed to arrive within a specified amount of time. There are other patents that “claim” to have a method of guaranteeing that an e-mail will be sent to another person on the Internet, however, the main flaw with these approaches is the fact that they require a special priority e-mail server to be connected to the Internet and thus, the World Wide Web. The priority e-mail server will send out its priority e-mail and associated files when it is supposed to, but then it has to travel through the Internet exactly the same as any other piece of data. The only guarantee they can provide is really that they will guarantee that an e-mail marked as priority sent from their proprietary server will be placed on the Internet. Once on the Internet, the e-mail and associated files is routed like any other packet of data. If it makes it on time, then great, but there is no way to guarantee that! It has no guarantee that it will arrive any sooner than if “Jane Doe” sends an e-mail telling her friend “Laura Smith” that “Bobby told Mary that Jimmy said that Lisa told her that . . . ”. The two e-mails are treated exactly the same when they are traveling through the Internet. There is no distinction associated with the data packets. To have a method of which any e-mail or file will be guaranteed to arrive at a specified time within a specified amount of time, the following steps must be done:
1) A central organization must be created or an established organization such as Fed-Ex™, DHL™, UPS™ or the United States Post Office could serve as the entity or coordinator that would be responsible for operating the priority e-mail and document delivery system. They would be responsible for monitoring and carrying out the tasks of collecting the established fees associated with priority e-mail handling and guaranteeing that a particular e-mail or document will arrive when it is stated to. The document referred to is not the same physical document that a person brings in to the priority e-mail handling facility center, it is scanned into a computer, and this electronic representation of the physical document will be sent through the same as a priority e-mail. The invention is not limited to e-mail, it also encompasses scanned documents, electronic audio files such as MP3 or WAV files, electronic video files such as MPEG or AVI files, and any file type that could be attached to an e-mail document.
2) A fee must be charged for sending a priority e-mail, priority electronic documents or priority files. This fee will guarantee that servers and routers throughout the net will be paid for establishing a priority handling of data throughout the Internet.
3) The server and router software must be modified to enable a priority handling of data packets that are identified through TCP/IP protocol as being of priority status in addition to saving a database of information regarding priority packet travel information.
4) A receipt of the record of travel must be created for each packet of data, so that the servers that route the data packet through the Internet in the shortest amount of time, and with the least amount of hops, will be paid a percentage for each priority data packet that is sent through. 5) A map will have to be created to detail all the server and router IP addresses to give a priority “routing map” of where the majority of the priority traffic will flow through. The TCP/IP protocol allows for destination addresses to be encoded in the data packets that will be used in conjunction with the priority routing map. This will guarantee that the packets are sent through the Internet with the least possible overhead. 6) A auditing system must be established to prevent fraud in receipt generation. The reason for this is that “Joe Schmo” who has a server connected to the Internet, writes a program that will try to force as many priority data packets through “His” server, and thus sit back and collect the percentages on each data packet sent through the server. In reality, the route taken through his server through the Internet to get the message from point A to destination Point B is not the most efficient route. This may happen now and then, but if a pattern of abuse is noticed, then “Joe Schmo's” server will be taken out of a priority packet routing server map. It could happen that some unscrupulous individuals will write code that will try to force all priority e-mail data packets to be routed through their server or router to make lots of money at the expense or the controlling entity or organization running the priority e-mail system.
7) A coding system must be established to ensure that each server or router on the Internet that has the modified software that will ensure rapid handling of priority mail packets, will be able to be uniquely identified in the packet travel receipt. The packet travel receipt will contain information as to time of travel through each server or router, the address of each server or router, and the total travel time for the priority data packet. This may or may not require encryption of individual data packets.
8) A system of payment must be established to ensure that each server or router that is participating in the priority e-mail system gets paid their percentage due. If there is no incentive for anyone or any institution operating a server or router to update their software and maintain a database of priority packet travel logs, then why would they want to do that?

An optional infrastructure utilizing Hotels, Motels, Conference Halls, Exhibition halls and even normal distribution outlets for the priority mail company could be utilized to insure contact with their employees or some non-affiliated person that needs to be in contact. If for example, a person “John Doe” is working for the Acme corporation, and is away on business out of state or out of the country, the company can simply send a priority e-mail to the person, but this would entail that the person be able to get on-line with their PC. If for some reason, the person needs to review a contract (that they lost, forgot to bring, or has been updated since they have been out on the road) before going to a big meeting or presentation, the company can try to deliver a paper copy to the individual, which could take a minimum of a day. Instead of wasting valuable time, the company could either send an electronic version of its contract to the hotel, and hope that they have a printer that works and is in color (if needed), or they can send someone to the closest priority e-mail/document center and have them scan in the contract, and electronically send the data through the Internet through the priority e-mail/document protocol. The person can then call the desk (if an affiliate Hotel is used) and have a printed copy(s) brought up to their room for review. It may be that an additional charge would be imposed for having to electronically scan in the document. What would normally take many hours, or even days with normal delivery services, would be reduced to the time it takes to scan a document and then print it out. A person could have a copy of an important document in minutes instead of hours or even days. If the Hotel, Motel, Conference Hall, or Exhibition hall is not affiliated with the priority e-mail/document center, then the person could run out to the closest priority e-mail/document center and have it printed out there. It could even be possible to have any important e-mail or document that does not need to be printed out, placed on a floppy disk or compact disk (CD) and picked up by the employee at the same local e-mail/document center. They could then run the file on their own laptop or notebook PC to view the content. Even if there is no available Internet connection for the employee, they could still get their e-mail. Services could be additionally provided in which the employee must send an updated document copy be sent back to the originator for review, in this case they would simply log in to the Internet web site of the priority e-mail/document center and upload the data to the priority e-mail/document server for a nearly instant delivery to the destination. For security and authentication purposes, an electronic digital signature could be attached to the printed documents that are sent back and forth. If for example, the president of Connecticut Analytical Corporation wants to make a contract with Microsoft Corporation, then each party could have a digital electronic signature that would be placed in lieu of the actual signature. The electronic digital signature would contain each parties registered electronic digital signature, along with information relevant to the document, such as:
1) The Title of the document (so the electronic digital signature could not be “copied” onto another document for fraudulent purposes.
2) The number of pages contained within the document (so pages could not be added or removed from the document).
3) The date and time that the document would be electronically signed.
4) A personal identification number (PIN) would be chosen by each individual to be used in all their electronic transactions. (This would prevent someone with access to an authentic electronic digital signature from being able to impersonate another individual). An optional code word, phrase could be encoded into the encrypted bar code that would be unique to that particular transaction.
5) A document checksum could be applied to the document to thwart any reuse of the electronic digital signature. This checksum would ensure that either party changed no text or wording.
6) Optionally, a third party company could be responsible for holding copies of each party's electronic contracts or electronic documents to be used later in case document verification is needed.

When all this information is encoded, it would form a legally binding contract that would enable each party to immediately fulfill their obligation to the terms of the contract. A later “mailed” physical copy could be sent and signed when convenient. This electronic document signing would enable speedy implementations of contracts between multiple parties. The electronic digital signature could appear as in the form of an encrypted bar code that used on many mail systems for postage. The combination of all this information, encoded into an encrypted bar code like graphic, would permit safe and secure transactions to be realized. The electronic digital signature could also have color information placed inside, which would require any reproduction done on a black & white copier to be guaranteed as a reference copy, and not an original copy. The color originals could be distributed to certain key individuals throughout the organization and thereby control the distribution of sensitive documents. Even if someone was able to make a copy of one of these electronic digital signatures, they would have to create a document that has the exact same number of pages, the same title, same time and date, same number of words and letters, and page layout as the original. There would be no way for anyone to alter the document without anyone knowing!

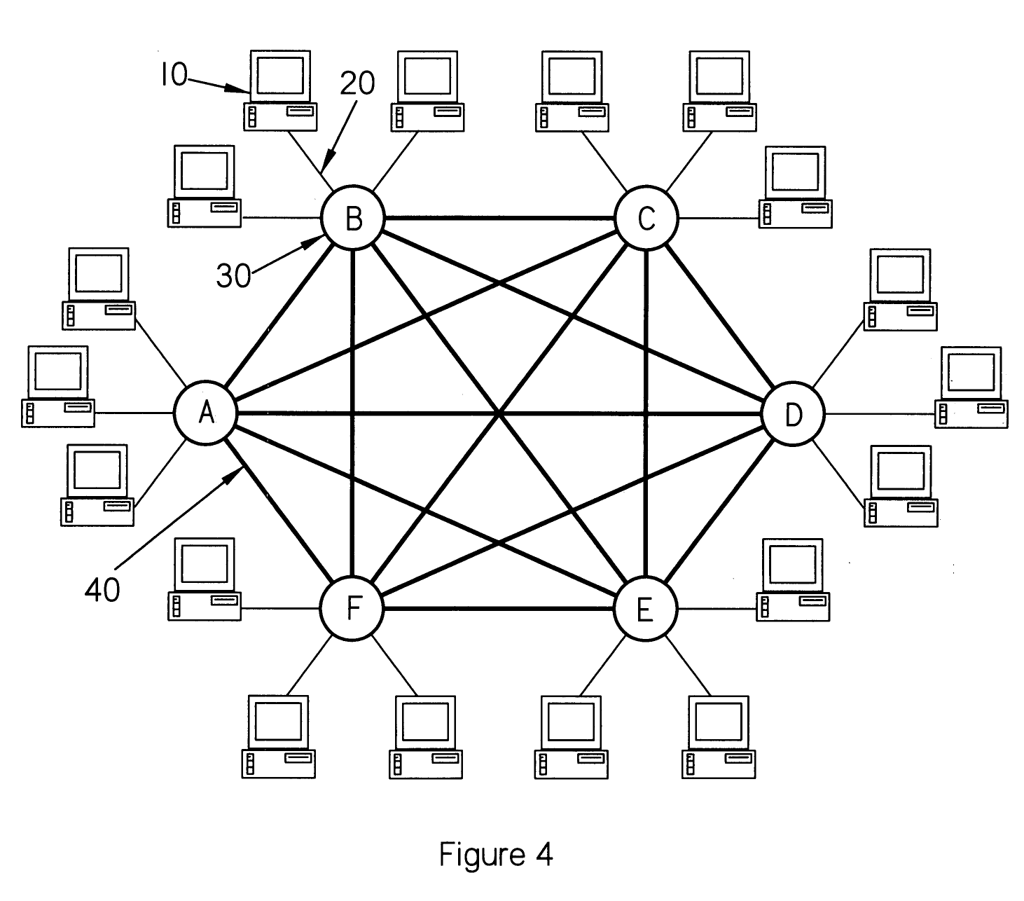

The priority e-mail/document would primarily entail the use of certain bits in the IP layer and the TCP layer. These two protocol layers will be instrumental in guaranteeing the prompt and speedy transmission throughout the Internet. To show how this would happen, we will look at a typical example of how a document—broken down into data packets—will traverse the Internet. FIG. 4 shows a relatively simple network of computers 10 tied or connected to their ISP's through a connection 20 which could be a DSL connection, dial-up connection, cable modem, or a “non-physically connected” wireless RF link. The ISP and Internet server or router will be shown as a single circle 30 for simplicity. Each ISP and Internet server/router 30 combination will be designated a letter from “A” to “F”. Even though there are just a handful of computers 10 connected together, the information traveling throughout the small “Simplified Internet” has a variety of destination routes to travel. The main trunk lines 40 that tie all the ISP's together will route and channel data throughout the simplified Internet. One can see how the number of possible routes throughout the simplified Internet of only eighteen computers connected through six ISP's can get pretty messy in a hurry! Imagine how much more complex it is with literally millions of computers tied to a gigantic world wide Internet!

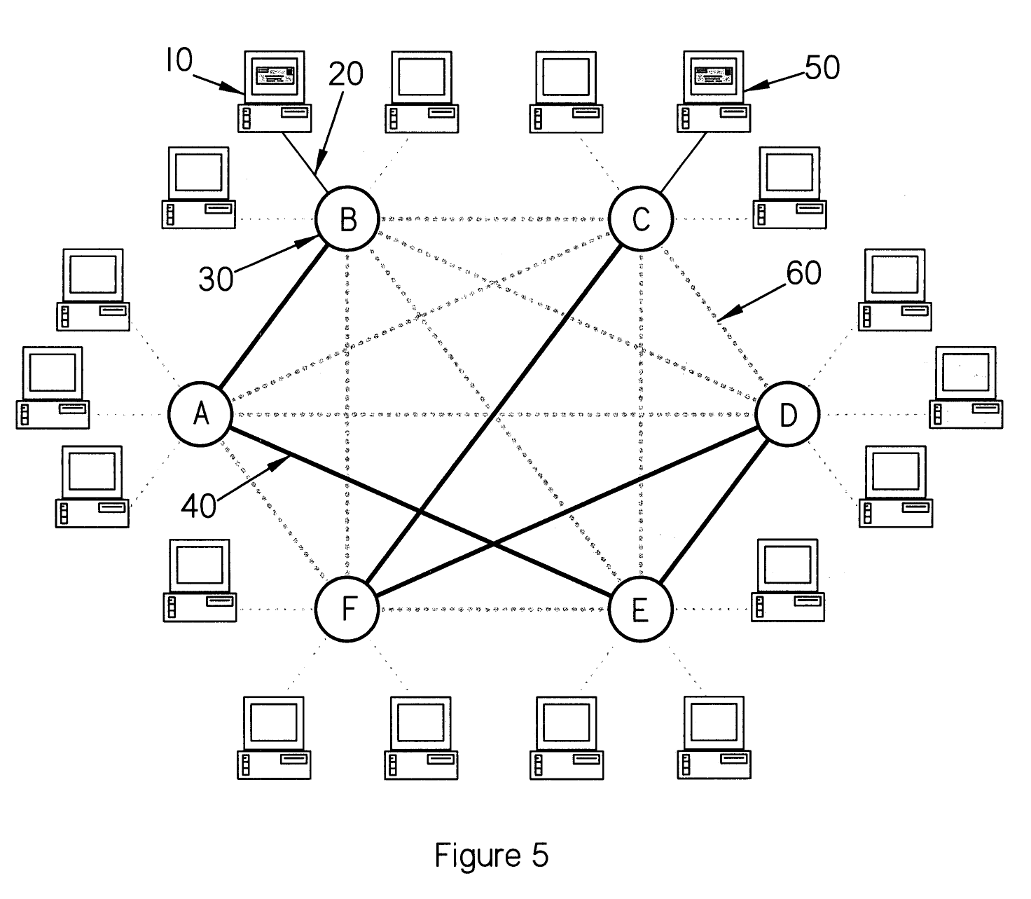

FIG. 5 details how a possible routing of e-mail would be handled in this simplified case. The user of one computer 10 wants to send an e-mail through to the user at a second computer 50. The user “sender” 10 would connect to their ISP through a connection 20 which could be a DSL connection, dial-up connection, cable modem, or a “non-physically connected” wireless RF link. The user “sender” would log onto their ISP homepage and then activate their e-mail client. Typical e-mail clients would Outlook Express or Eudora. The e-mail client would then allow the user 10 to compose or create an e-mail to be sent to the designated receiver, in this case the designated receiver is 50. Through a series of commands outlined in the previous section on SMTP, the e-mail text message would be sent throughout the Internet to other Internet servers/routers (A, B, C, D, E, F) throughout the Internet. Each Internet server/router would pass off the data packets that comprise the full e-mail on a first come, first served basis. There is no regard to priority here. The e-mail data packets could travel from the initial Internet server/router 30 (designated as B), and then on throughout the Internet going from the main trunk lines 40 to each additional Internet server/router 30, from A to E to D to F and finally to C. When the final e-mail data packet is sent, it is reassembled into the correct order to make up the message. The e-mail message is stored on the receivers ISP. And will stay there until a specific amount of time has expired, or the intended receiver 50 logs onto their ISP and checks their e-mail. Not every trunk line throughout the Internet is used, as is shown by the dotted lines 60. The basic structure of the Internet will try to make the most efficient number of connections. The total path that the individual data packets take are not always optimized for efficiency, and not every data packet will nesacerily take the same path throughout the Internet. A better method would be to have a pre-designated high-speed route in which to send all the individual data packets.

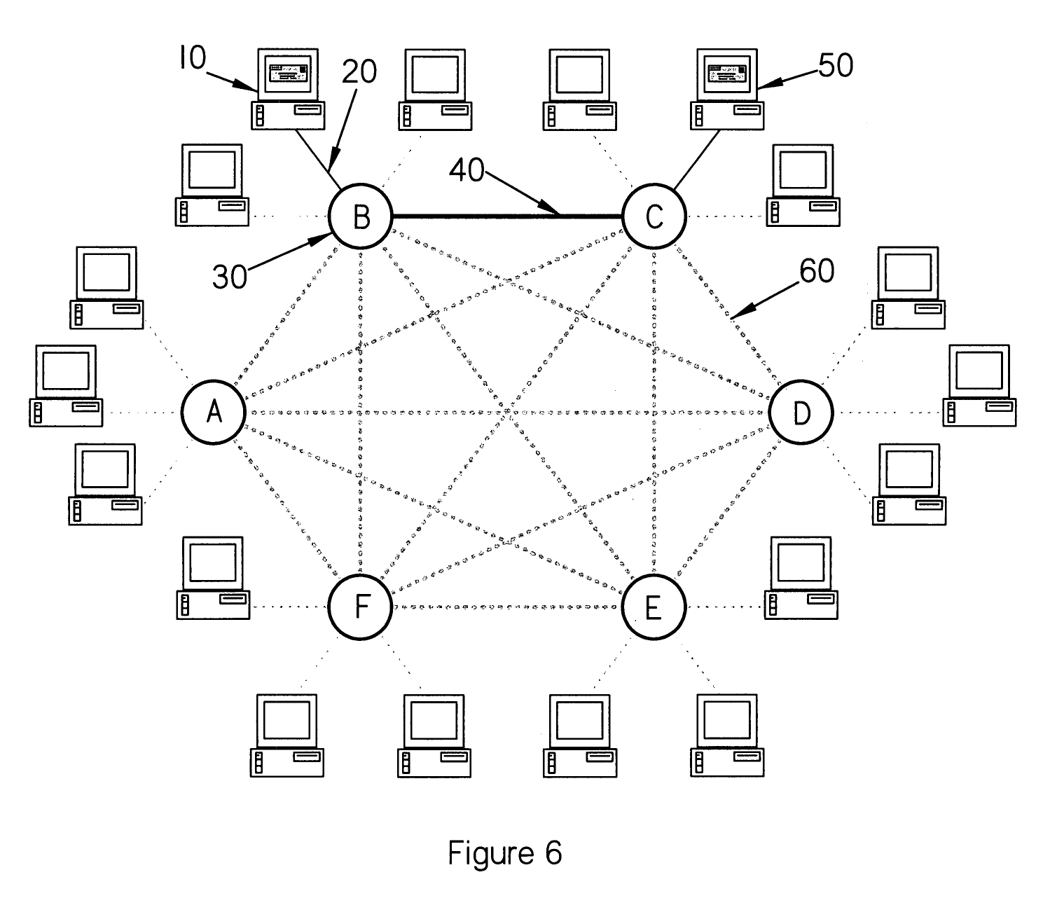

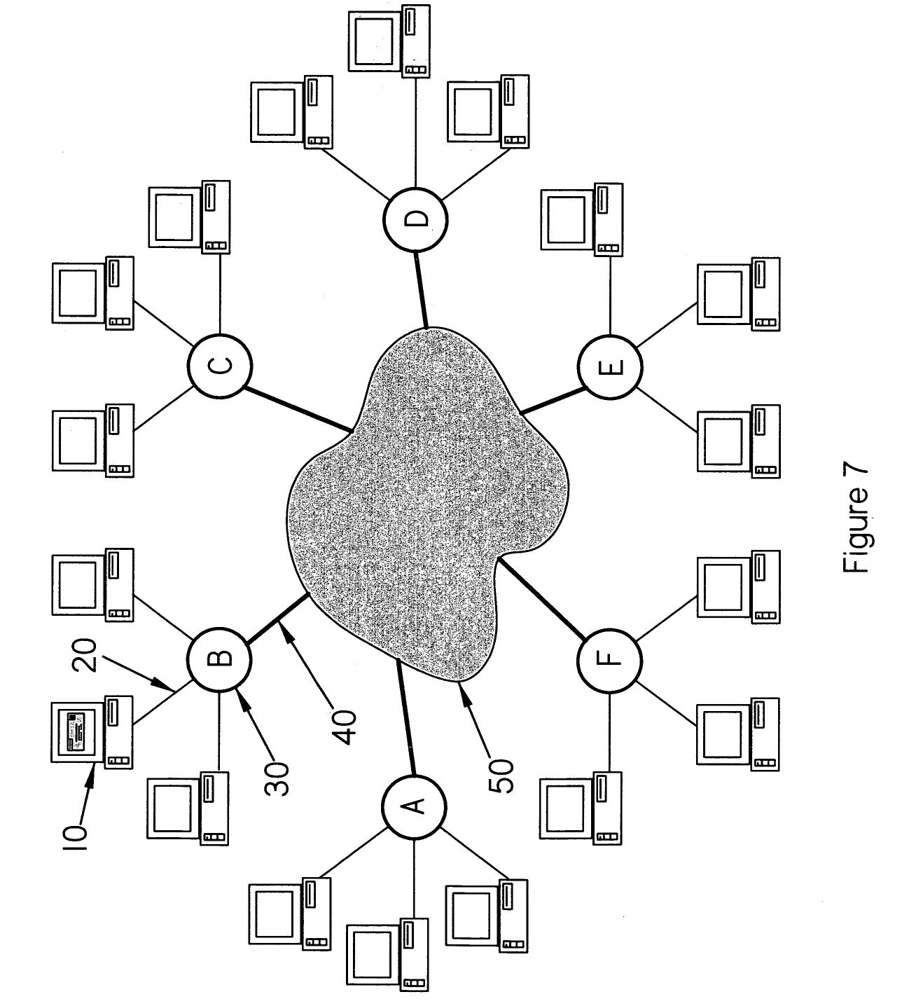

FIG. 6 shows the same simplified Internet as before, the only difference being that the route taken will be more efficient and faster than before. The user of one computer 10 wants to send an e-mail through to the user at a second computer 50 as before. The user “sender” 10 would connect to their ISP through a connection 20 which could be a DSL connection, dial-up connection, cable modem, or a “non-physically connected” wireless RF link. The user “sender” would now encode their e-mail or electronic document to be designated as a priority e-mail/document. The individual Internet servers equipped with the priority e-mail server software that would allow them to understand the priority bits set on the TCP and IP datagrams, would route the individual data packets by the shortest, fastest, and most efficient means available. (It should be pointed out that shortest, doesn't always mean the fastest! Depending on Internet traffic and network failures, this could mean that a shorter physical connection could take longer. By establishing a “priority” status to the individual data packets, they would be guaranteed preferred routing). In this particular case, the most efficient route is through the designated trunk line 40 between B and C. The leisurely route utilizing other unused trunk lines 60 is not taken. Instead of traveling back and forth throughout this simplified Internet, the data packets are efficiently routed through to allow for the shortest amount of time. The priority e-mail system will send a receipt to the sender that the e-mail has arrived at its designation. A second receipt will be generated and sent to the original sender when the e-mail is read from the receivers ISP. The intended receiver 50 then finally reads the e-mail after they log onto their ISP. When they check their e-mail, a receipt will be sent to the priority e-mail/document website, and sent to the original sender. The only drawback to this is the fact that the person who receives the priority e-mail or document will not know it until they log onto their ISP and check their e-mail. A better method would be for the sender of the priority e-mail to have the ability to have a pager, cell phone, home phone, work phone, Hotel phone, Conference hall phone, etc. notify the recipient of the priority e-mail that an e-mail has been sent. As soon as they received the notification, they could check their e-mail. This could be an optional service for the priority e-mail/document provider. The Internet is not as simple as our previous description. The fact that it contains millions of nodes and a plethora of possible connection possibilities mean that anyone would have to be insane to propose such a system—fortunately we are insane! The Internet would look more like a large nebulous cloud as in FIG. 7. The large nebulous cloud 50 of possible connections is spread out throughout the world. If a user 10 wanted to send an e-mail to someone connected onto the Internet, then they would connect to their ISP through a connection 20 which could be a DSL connection, dial-up connection, cable modem, or a “non-physically connected” wireless RF link. The local ISP 30 would send the data packets comprising the e-mail and sent through an Internet router to the Internet through a high bandwidth trunk line 40. Once the packets are encoded with the appropriate priority bits set, the subsequent Internet servers/routers would be configured to permit “preferred” status of the priority data packets.

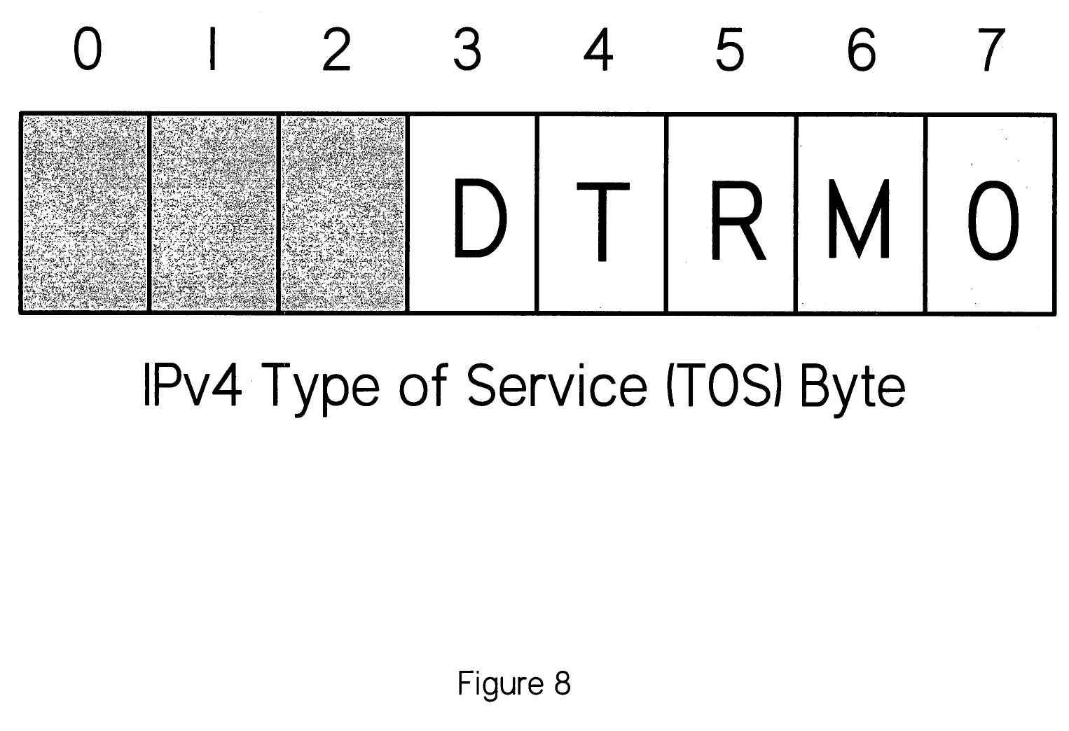

FIG. 8 shows one possible means of establishing a priority by using the Type Of Service (TOS) byte. The byte is composed of a single 8-bit byte. The TOS byte is for Internet service quality selection. The type of service is specified along the abstract parameters of precedence, delay, throughput, reliability and cost minimization. These abstract parameters are to be mapped into the actual service parameters of the particular networks the datagram traverses. The definition is for the current version of Internet Protocol—version four. Bits zero through two, handle precedence as follows:

| BIT 2 | BIT 1 | BIT 0 | Description |
|---|---|---|---|
| 1 | 1 | 1 | Network Control |
| 1 | 1 | 0 | InterNetwork Control |
| 1 | 0 | 1 | CRITIC/ECP |
| 1 | 0 | 0 | Flash Override |
| 0 | 1 | 1 | Flash |
| 0 | 1 | 0 | Immediate |
| 0 | 0 | 1 | Priority |
| 0 | 0 | 0 | Routine |

The next bits in the byte control delay, throughput, reliability and cost minimization, as outlined in the following:

Bit three (D)=Delay
0=Normal Delay
1=Low Delay

Bit four (T)=Throughput
0=Normal Throughput
1=High Throughput

Bit five (R)=Reliability
0=Normal Reliability
1=High Reliability

Bit six (M)=Minimize Monetary Cost
0=Normal Monetary Cost
1=Minimize Monetary Cost

Bit seven is reserved and is set to zero.

It is important to note that if this invention were to be put into effect at this very moment, not every network would treat the datagrams with the specified bits set, the same way, that is to say, some networks would adhere to the strict definition of Delay, Throughput, Reliability and Cost Minimization, while others would not. Two possible options for indicating that a data packet is to be marked as a priority through IP, are using the IP TOS byte, and using the IP options byte. The two (TOS & Options) could be used together or separately, depending on implementation throughout the Internet. It may be that it is impossible or impractical to require Internet priority server/router software to use one or the other. The TOS byte has been previously discussed and will not be addressed further in this section, the IP options byte; however, will be expanded upon. The IP Options byte contains 32 bits of information comprising the following:
1) Security: Used to send packet security information (military use).
2) Loose Source Routing: Specifies nodes that the packet must traverse en route, but allows arbitrary intermediary nodes.
3) Strict Source Routing: Specifies nodes that the packet must traverse en route—the packet is restricted to only traverse those specific nodes.
4) Record Route: Allows the packet to record which nodes (up to the maximum header length) have been traversed en route.
5) Internet Timestamp: Similar to Record Route, but each entry is also branded with the router time (GMT) in milliseconds.

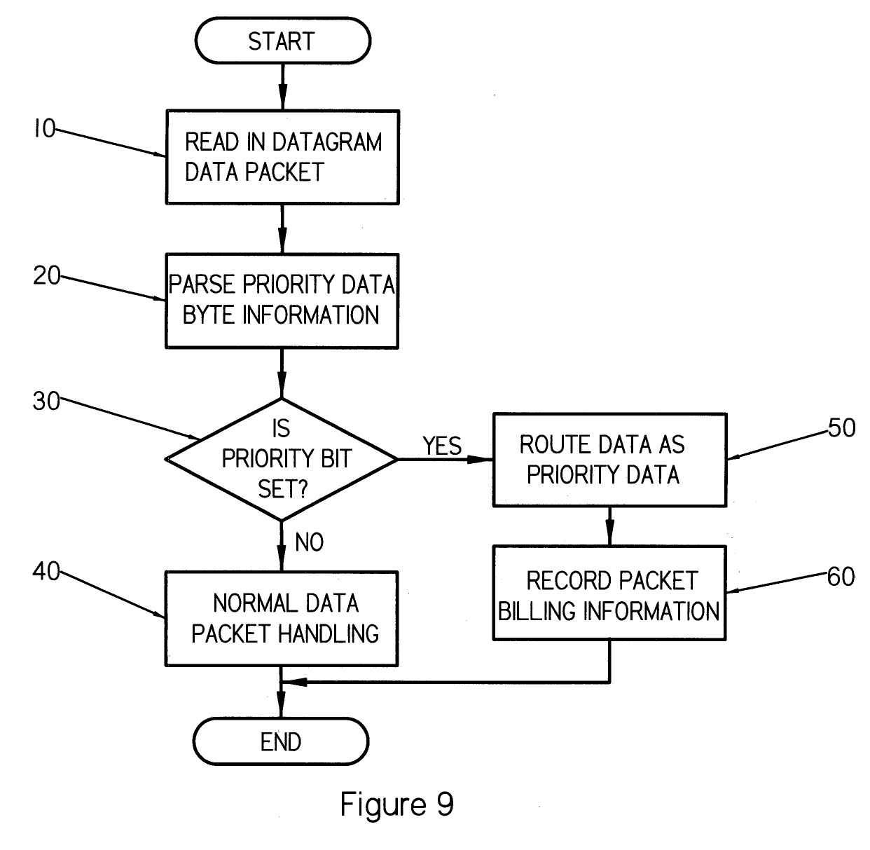

The Strict Source Routing could be used to make sure that the priority data packets stay on the priority Internet sub-network. The Record Route feature will enable a map of where the priority data packet traveled, to enable billing to be realized, along with the Internet Timestamp, to record the amount of time taken and find any delays in the routing. For the TCP side of things, two possible options also exist for indicating that a data packet is to be marked as a priority. Using the TCP Flag bits, and encoding the data through the security protocols, and optionally, placing an encoded “session key” somewhere in the data portion of the data packet to indicate that this data is of a priority nature. With the combination of the TCP and IP protocols, it would enable a sub-network to exist inside the Internet, that would be used to route priority data through to its destination. This is the preferred embodiment of the invention, and as such is not limited to TCP, but also UDP (User Datagram Protocol). Although UDP could also be used to implement the described invention, TCP is more widely used, and will be the preferred embodiment. A very generalized case of how a real world IP router on the Internet would handle the processing of prioritized data packets for either priority e-mail or priority file routing is detailed in FIG. 9. The first step is to read the incoming data packet into memory 10. The software running on the IP router would then parse each individual byte contained in the incoming data packet to determine which byte contains the priority status information bits 20. Once the priority status bits are identified, a decision must be made on how to retransmit the data packet based on the information determined from whether the priority bits are set or cleared 30. If the priority data bit(s) is not set, then the data packet is routed through the IP router as normal, with no special priority 40. If the priority bit(s) is set, then the data packet is routed through the IP router with the highest priority over ordinary, routine data packet routing 50. In addition to routing the data packet through the IP router with a high priority, the billing information is stored in a database, along with source and destination mapping 60. This is a very simplified description as to how an IP router that handles bulk Internet traffic could carry out the task of giving data packets that are encoded with a special priority bit(s) preferred routing through the Internet to make sure that the destination is reached in the shortest amount of time. In order for the described invention to work at peak efficiency, several major Internet routing nodes must contain software that is modified to address how to handle reading in data packets that are encoded with a priority status bit(s). This is no easy task, as the main Internet routers that comprise the backbone of the Internet would require a software update that would contain specific instructions on how to do this. If this were a strictly voluntary effort, then who in their right mind would do it? Why this would work is the fact that the priority data traffic that is routed through each backbone router, would be paid a small percentage for each priority e-mail or priority file that is given priority handling through their Internet router. To make the described invention work, an actual priority e-mail or priority file handling entity would have to do the following steps:
1) A central organization must be created or an established organization such as Fed-Ex™, DHL™, UPS™ or the United States Post Office could serve as the entity or coordinator that would be responsible for operating the priority e-mail and document delivery system. They would be responsible for monitoring and carrying out the tasks of collecting the established fees associated with priority e-mail handling and guaranteeing that a particular e-mail or document will arrive when it is stated to. The document referred to is not the same physical document that a person brings in to the priority e-mail handling facility center, it is scanned into a computer, and this electronic representation of the physical document will be sent through the same as a priority e-mail. The invention is not limited to e-mail, it also encompasses scanned documents, electronic audio files such as MP3 or WAV files, electronic video files such as MPEG or AVI files, and any file type that could be attached to an e-mail document.
2) A fee must be charged for sending a priority e-mail, priority electronic documents or priority files. This fee will guarantee that servers and routers throughout the net will be paid for establishing a priority handling of data throughout the Internet.
3) The server and router software must be modified to enable a priority handling of data packets that are identified through TCP/IP protocol as being of priority status in addition to saving a database of information regarding priority packet travel information.
4) A receipt of the record of travel must be created for each packet of data, so that the servers that route the data packet through the Internet in the shortest amount of time, and with the least amount of hops, will be paid a percentage for each priority data packet that is sent through.
5) A map will have to be created to detail all the server and router IP addresses to give a priority “routing map” of where the majority of the priority traffic will flow through. The TCP/IP protocol allows for destination addresses to be encoded in the data packets that will be used in conjunction with the priority routing map. This will guarantee that the packets are sent through the Internet with the least possible overhead.
6) A auditing system must, be established to prevent fraud in receipt generation. The reason for this is that “Joe Schmo” who has a server connected to the Internet, writes a program that will try to force as many priority data packets through “His” server, and thus sit back and collect the percentages on each data packet sent through the server. In reality, the route taken through his server through the Internet to get the message from point A to destination Point B is not the most efficient route. This may happen now and then, but if a pattern of abuse is noticed, then “Joe Schmo's” server will be taken out of a priority packet routing server map. It could happen that some unscrupulous individuals will write code that will try to force all priority e-mail data packets to be routed through their server or router to make lots of money at the expense or the controlling entity or organization running the priority e-mail system.
7) A coding system must be established to ensure that each server or router on the Internet that has the modified software that will ensure rapid handling of priority mail packets, will be able to be uniquely identified in the packet travel receipt. The packet travel receipt will contain information as to time of travel through each server or router, the address of each server or router, and the total travel time for the priority data packet. This may or may not require encryption of individual data packets.
8) A system of payment must be established to ensure that each server or router that is participating in the priority e-mail system gets paid their percentage due. If there is no incentive for anyone or any institution operating a server or router to update their software and maintain a database of priority packet travel logs, then why would they want to do that?

Once the designated Internet routers have agreed to be part of this priority Internet service, they will have to modify the Internet server/router software to make use of the TCP and IP bits that determine priority status and urgent data in addition to implementing a local database to store a priority routing table, and route information for each priority e-mail or priority file routed through their Internet server/router. Initially there might only be a few Internet servers/routers that will comprise the priority Internet, which will actually be a sub-network of the Internet. With a minimum number of Internet servers/routers the priority Internet will be formed, when a priority e-mail or priority file is sent, it will be processed by the Internet servers/routers with the priority software running on them. As the priority e-mail or priority file is transmitted throughout the Internet, it will be passed through each participating Internet server/router (and non-participating Internet server/router if need be) that contains a routing table for each additional priority Internet server/router along the path to the destination IP address. As each participating Internet server/router passes the priority data through, it will log the data packet information in the local Internet server/router database to be later used for billing purposes. This will additionally work as a cross check for billing purposes with the central organization running the priority e-mail/priority file system. It could occur that some unscrupulous individuals may try to produce a fraudulent listing of priority data traffic, in this unfortunate case, the stored database record information would be used by each corresponding entity to validate their billing and payment information. The routing information for each priority data packet would be recorded by the controlling organization for the priority data service. This information will enable the controlling entity or organization to develop heuristics for priority data packet routing, and will also enable a detailed auditing to cross check the billing statements sent by the participating Internet priority server/routers. If some unscrupulous individuals decide to modify their Internet priority server/router software to force a capturing of priority data packets to pad their account due to the increased priority data flow—then this could be identified in a routine auditing of billing information. A means of coding the priority data packet must be established to prevent an unauthorized user from “forcing” their data packets onto the priority Internet sub-network. To prevent an unauthorized individual from obtaining a free ride on the priority Internet sub-network. A coding scheme could encompass establishing a secure connection to be made for each session of sending priority data packets by creating a unique “session key”, or “session word” to be used until the appropriate number of priority data packets are sent. There are several established means of sending secure data through the Internet, so this will not be expanded upon here, aside from stipulating that the software that initially sends the data to be placed onto the priority Internet sub-network, have a compatible security protocol as each priority Internet server/router. This will prevent an unauthorized individual from placing their own data to be routed through the Internet as priority data. The central organization controlling the priority Internet sub-network will have an option of being the single “point of entry” (POE) to the priority Internet sub-network, where each priority e-mail or priority file will have to be uploaded to before being placed onto the priority Internet, or they have the option of selling or licensing their proprietary software to individual companies or individuals. The proprietary software will enable a secure session key to be generated to each priority e-mail or priority file transmission. With the use of the proprietary software, the controlling entity could just sit back and reap the rewards of payment for each priority transaction made. The controlling entity could additionally sell or license their proprietary software to various Hotel/Motel chains, Airports, Bus terminals, Internet Coffeehouses, Businesses, and Government institutions. This would free up the controlling entity from always having to be the POE, although it might be preferential to maintain control the flow of the priority data traffic. It is important to point out that just because the precedence bits of an IP datagram are set to priority, it won't be allowed to be routed through the priority Internet sub-network, it will just be routed through as normal Internet traffic. The combination of several factors will guarantee that data marked as priority data will be sent through the priority Internet as urgent or as having priority status. The combination of the correct TOS and Option bits set on the IP portion with the correct Flag bits and “session key” encoded data on the TCP portion of things will be required for any and all data to be treated as having a priority status. Without this combination of factors, anyone with a basic knowledge of Internet networking theory could write a program that would allow them to set the appropriate bits of the TCP/IP suite to allow them to have a free ride on the priority Internet. As one can see, with the appropriate infrastructure, a priority data service could be carried on the existing Internet, with a few minor software modifications required on several Internet servers/routers. As time goes by, more and more “backbone” Internet servers/routers may want to participate in becoming part of a larger and larger priority data Internet sub-network that will allow each Internet server/router to produce revenue for itself through the transmission of priority data packets. Existing “normal” traffic flow will not be affected, or only very slightly affected, as the priority data traffic will take precedence on routing. It will be important to update Internet priority server/router, routing tables as more and more Internet priority server/routers come online. With more and more participating Internet servers/routers passing priority data traffic through the Internet, the efficiency of the overall priority network will increase in efficiency, as it will have more avenues to route priority data, and preferred data routes could be established. The trick is to balance the priority data traffic flow with the participating priority Internet servers/routers on the network. Some priority e-mail or priority data will have to be somewhere by a certain time, and this may allow for the flexibility to use less efficient routing paths when time permits. The key factor being that you want to make the priority e-mail customer happy, while at the same time keeping the priority Internet server/router in the queue of priority data packets. This should not turn out to be such a problem, because it usually takes (depending on file size) only seconds with a common home DSL connection to transfer e-mails and files through the Internet. This would allow the company running the priority data service (PDS) to be able to tell their customers that their priority e-mails, or priority data files will be instantly transmitted through the Internet via. The Internet priority sub-network. The term “instantly” would in this case mean anything from a couple of seconds to as much as a minute. This flexibility in the “instant” transmission time will allow for a coordinating entity acting as the PDS to keep their priority e-mail and priority file customers, while also maintaining a statistical guarantee that at least some portion of priority data traffic will be routed through their priority Internet server/routers. As stated before, this preferred embodiment of this invention details use of IP version 4, if the change to IP version 6 is implemented, then some minor alterations may need to be made for the software running on the priority Internet servers/routers to accommodate this change; however the basic methodology of this described invention holds.

It should also be stated that a method of collecting payment of priority data service could be enacted as a COD (Cash On Delivery) basis. When the sender requests a priority e-mail or priority data file be sent as a COD, then it will first be encrypted as a “one time pad” cipher. The one-time pad is the most secure, and one of the simplest, of all ciphers. It was invented and patented just after World War I by Gilbert Vernam (of AT&T) and Joseph Mauborgne (USA, later chief of the Signal Corps). The fundamental features of this cipher are that the sender and receiver each have a copy of an encryption key, which is as long as the message to be encrypted, and each key is used for only one message and then discarded. For complete security, the key must be random, that is without pattern, and must remain unknown to any attacker or unauthorized individual. In addition, the key must never be reused, otherwise the cipher becomes trivially breakable. For example, two identical pads of paper with random letters can be exchanged between sender and receiver, later, when they wish to send a message, the sender uses the (random) key in the pad (say that on the first page of his pad) to encrypt a message. One technique is to exclusive OR, XOR (i.e., combine in a particular way) the first character of the key with the first character of the plaintext, the second character of the key with the second character of the plaintext, etc. Even a simple letter-substitution cipher as has been known at least since Julius Caesar's time can be used—as long as the offset for each letter is determined individually by the corresponding random letter of the key (the traditional “Caesar cipher” used a single offset for the whole message). He then sends the encoded message to the receiver, who decrypts it with his copy of the first page of the pad. Both now discard the used key page, having used it only ‘one-time’. One-time pads are information-theoretically secure, in that if all the conditions are met properly (i.e., the keys are chosen randomly, are at least as long as the message, and are never reused), then the ciphertext gives the attacking cryptanalyst no information about the message other than its length. This is a very strong notion of security, and implies that one-time pads are secure even against cryptanalysts with infinite computational power. The problem as pointed out with OTP's is that the sender and receiver need a copy of the OTP. For security purposes, this is a nightmare, but for the disclosed invention, it is a benefit. It provides a means of delivering a priority e-mail or priority data to the intended recipients PC or computer, but will prevent that information from being viewed until the COD recipient pays a nominal fee to “unlock” or decrypt the information. When the sender sends priority data as a COD, then the priority service provider will automatically generate a random OTP for that particular document or file. The random OTP will be stored on the priority service providers database to be sent at a later time when the COD recipient submits payment to the priority service provider. When payment is received (electronically, in the form of a credit or debit card, or some comparable form of electronic credit), then the priority service provider will then send its copy of the OTP to the recipient who can then use it to “unlock” or decrypt the file. One-time pads have been used in specialized circumstances, since the early 1900s; the Weimar Republic Diplomatic Service began using the algorithm about 1920. Poor Soviet cryptography (broken by the British, with messages made public in two instances in the 1920s), forced them to improve their systems, and they seem to have gone to one-time pads for some uses around 1930. KGB spies also used pencil and paper one-time pads to communicate. Beginning in the late 1940s, the U.S. and British intelligence agencies were able to break some of the one-time pad traffic to Moscow during W.W.II as a result of errors made near the end of 1941 in generating/distributing the key material. This huge, decades long effort was code named VENONA. The “hot line” from the White House to the Kremlin during the Cold War reportedly used a OTP; this line was used so infrequently that pad exhaustion was a minor concern relative to providing the necessary security. The information-theoretic security of one-time pads is wholly dependent upon the randomness (or unpredictability) and secrecy of the key pad material. If the key material is perfectly random (and never becomes known to an attacker), then it is information-theoretically secure. If the OTP material is generated by a deterministic program, then it is not, and cannot be, a one-time pad; it is a stream cipher. A stream cipher takes a short key, and uses it to generate a long pseudorandom stream, which is combined with the message using a mechanism similar to that used in a one-time pad. Stream ciphers can be secure in practice, but cannot be absolutely secure in the same provable sense. At least one of the Fish ciphers used by the German military in W.W.II turned out to be an insecure stream cipher, not a practical automated one-time pad as seems to have been intended by its designers. Bletchley Park broke Lorenz machine messages regularly. None of these stream ciphers have the absolute, information-theoretical security of a one-time pad, although there exist stream ciphers that appear to be unbreakable in practice by a cryptanalyst without access to the key. The similarity between stream ciphers and one-time pads often leads cryptographic novices to invent (usually very insecure) stream ciphers under the mistaken impression that they are using one-time pads. An especially insecure approach is to use any of the random number generators that come with most computer programming languages and operating system call libraries. These typically produce sequences that pass simple statistical tests but that are nonetheless highly predictable—making them absolutely useless for cryptographic purposes. Though Cryptographically secure pseudo-random number generators exist that permit computationally secure stream ciphers, even these do not provide the information-theoretic security of a one-time pad, and a claim that a particular stream cipher is equivalent in strength to a one-time pad is often viewed as a clear sign of snake oil by professional cryptographers. Shannon's work can be interpreted as showing that any information-theoretically secure cipher will be effectively equivalent to the one-time pad algorithm. If so, one-time pads offer the best possible security of any cipher, now or ever. Since we are only trying to prevent a person from retrieving priority COD data before paying for that service, the OTP could very well be a simpler stream cipher. Depending on computer processing time, and the computers ability to generate random numbers, it should be a simple matter to generate OTP's that are reasonably sized. Other economic factors could determine that ordinary RSA encryption or PGP (Pretty Good Privacy) encryption will be good enough. After all, we are not dealing with National Security issues, we are only trying to ensure that the priority service provider gets paid the money that they are due. An OTP is a quick and secure method of sending COD priority data, and should not be that much of a problem with today's bigger and faster computers. As technology improves, the stuff we are doing today, will be laughed at in just a few years (as far as processing speed, memory size, overall computational power, etc.), as is normally the case! While the preferred embodiment of this patent applies to priority e-mail and priority data, it is not limited to said functionality. It is becoming more and more apparent that the Internet, and subsequently the World Wide Web, will become more and more utilized for applications that it was not originally designed for. Now a day, there is much discussion about using the Internet, and the WWW to provide phone service in addition to video conferencing. The described invention will be able to prioritize ANY data packets for routing throughout the Internet priority sub-network, which would include, e-mail, data files, voice traffic, video data, and any conceivable document conversion data. As the Internet and subsequently, the WWW get more and more tasked, it will naturally lead to unexpected delays in data traffic. An extreme amount of congestion could be realized in the not so distant future, the described invention will enable its customers a guaranteed priority routing through the Internet priority sub-network, while regular Internet data traffic will be subject to the first come, first served standard Internet router/server handling. In the event that some part of the Internet goes down, then with the described methodology of using an auditing process to form a “mapping” of portions the Internet, alternate “non-priority” routes could be used. This would guarantee that the priority data traveling through the standard Internet would have a higher probability of reaching its destination than normal Internet traffic. With the ability of utilizing a unique data byte in the data packet sent through TCP and IP protocols, different types of data would be treated differently. If only the priority bits were utilized (in the IP case), then the described invention would not be able to guarantee priority operation.

### Reference Numerals

FIG. 1:

Description of a datagram of an IP (Internet Protocol) data packet with each byte detailed as to its function and the number of bits contained in each designated byte for specific functions.

FIG. 2:

Description of a datagram of a TCP (Transport Control Protocol) data packet with each byte detailed as to its function and the number of bits contained in each designated byte for specific functions.

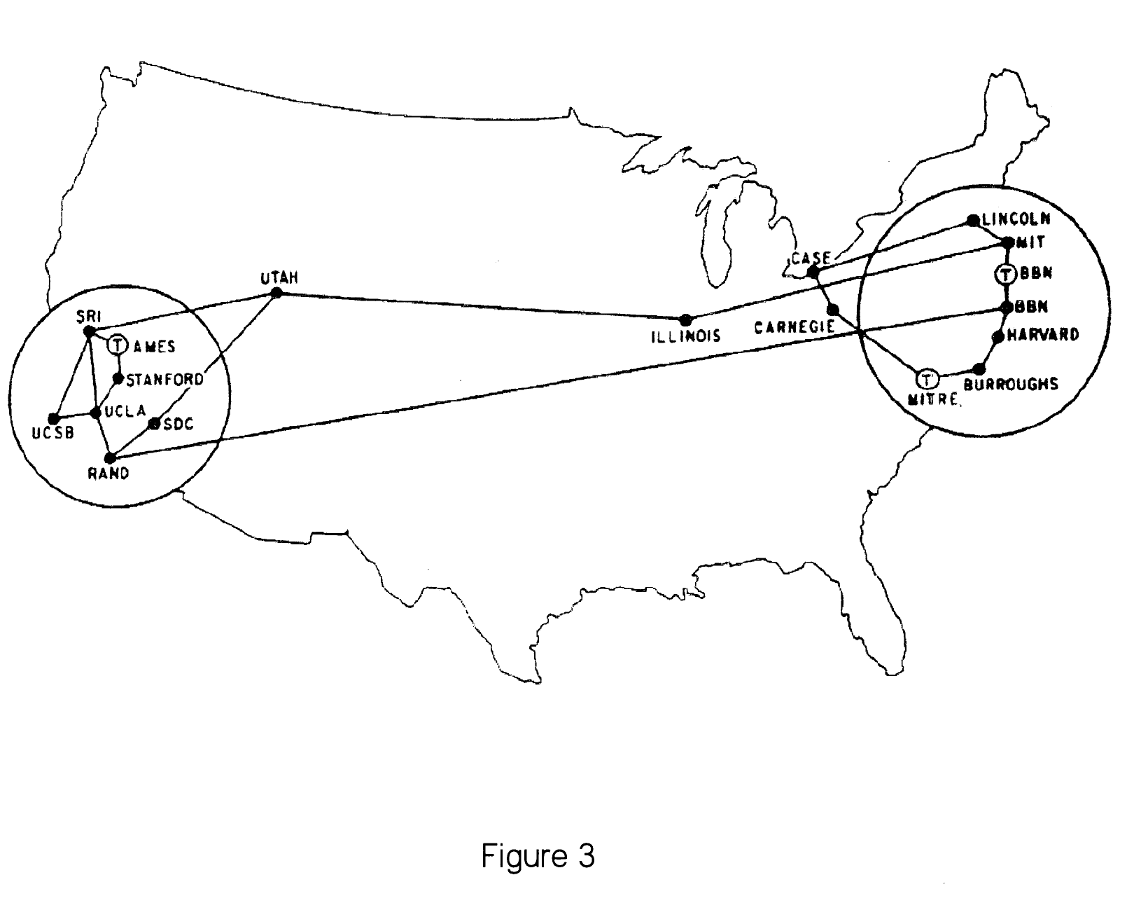

FIG. 3:

Descriptive image of a series of locations of various institutions located throughout the continental United States that contain Internet servers/routers, and the corresponding physical connections that allow them to be “Internetted” together.

FIG. 4:

10 Sender node (or originator of message computer) that will be used to create and send e-mail message to the designated receiver.

20 Connection for sender node to connect to their ISP (Internet Service Provider) that could be a DSL connection, dial-up connection, cable modem, or a “non-physically connected” wireless RF link.

30 The ISP and Internet server or router that will be used to connect the sender and receiver's computer to the Internet. Each ISP and Internet server/router combination will be designated a letter from “A” to “F”.

40 Main trunk lines that tie all the ISP's together will route and channel data throughout the simplified Internet.

FIG. 5:

10 Sender node (or originator of message computer) that will be used to create and send e-mail message to the designated receiver.

20 Connection for sender node to connect to their ISP (Internet Service Provider) that could be a DSL connection, dial-up connection, cable modem, or a “non-physically connected” wireless RF link.

30 The ISP and Internet server or router that will be used to connect the sender and receiver's computer to the Internet. Each ISP and Internet server/router combination will be designated a letter from “A” to “F”.

40 Main trunk lines that tie all the ISP's together will route and channel data throughout the simplified Internet.

50 Receiver computer (or destination node) that receives the priority e-mail message that was sent through the Internet from the sender (or originator node).

60 Unused main trunk lines that would normally tie all the ISP's together will route and channel data throughout the simplified Internet.

FIG. 6:

10 Sender node (or originator of message computer) that will be used to create and send e-mail message to the designated receiver.

20 Connection for sender node to connect to their ISP (Internet Service Provider) that could be a DSL connection, dial-up connection, cable modem, or a “non-physically connected” wireless RF link.

30 The ISP and Internet server or router that will be used to connect the sender and receiver's computer to the Internet. Each ISP and Internet server/router combination will be designated a letter from “A” to “F”.

40 Main trunk lines that tie all the ISP's together will route and channel data throughout the simplified Internet.

50 Receiver computer (or destination node) that receives the priority e-mail message that was sent through the Internet from the sender (or originator node).

60 Unused main trunk lines that would normally tie all the ISP's together will route and channel data throughout the simplified Internet.

FIG. 7:

10 Sender node (or originator of message computer) that will be used to create and send e-mail message to the designated receiver.

20 Connection for sender node to connect to their ISP (Internet Service Provider) that could be a DSL connection, dial-up connection, cable modem, or a “non-physically connected” wireless RF link.

30 The ISP and Internet server or router that will be used to connect the sender and receiver's computer to the Internet. Each ISP and Internet server/router combination will be designated a letter from “A” to “F”.

40 Main trunk lines that tie all the ISP's together will route and channel data throughout the simplified Internet.

50 Mass connections of Internet servers/routers that comprise the “real world” Internet. This includes all high bandwidth fiber-optic trunk lines, links and relays throughout the world.

FIG. 8:

Detail showing bit structure of single 8-bit byte of the IP datagram showing the TOS (Type Of Service) byte for IP version 4 (Ipv4) protocol.

FIG. 9:

10 Flowchart block diagram section showing how the incoming data packet would be into memory.

20 Flowchart block diagram section showing how the software running on the IP router would parse each individual byte contained in the incoming data packet to determine which byte contains the priority status information bits.

30 Flowchart block diagram section showing how the software running on the IP router would make a decision as to how to handle the routing of the data packet.

40 Flowchart block diagram section showing how the software running on the IP router would retransmit the stored or buffered data packet with regular (Non-Priority) status.

50 Flowchart block diagram section showing how the software running on the IP router would retransmit the stored or buffered data packet with special priority status, and would be placed ahead of regular non-priority status data packets.

60 Flowchart block diagram section showing how the software running on the IP router would record the billing information to be used later to generate a bill recording the amount of priority traffic routed through this particular Internet router.

1. a method for providing guaranteed priority delivery of electronic documents through the internet and world wide web.

2. a method as in claim 1 where the electronic documents are physical hardcopies.

3. a method as in claim 1 where the electronic documents are electronic media.
